(19) United States
(12) Patent Application Publication
(10) Pub. No.: US 2010/0252607 A1
(43) Pub. Date: Oct. 7, 2010

(54) Automatic nailing assembly

(76) Inventor: Matthew Forrest, Burnstown (CA)

Correspondence Address: GEORGE A. SEABY;SEABY & ASSOCIATES, 250 CITY CENTRE AVNUE, OTTAWA, ON, K1R6K7, CA

(21) Appl. No.: 12/659,922

(22) Filed: Mar. 25, 2010

Related U.S. Application Data
(60) Provisional application No. 61/202,781, filed on Apr. 3, 2009.

(51) Int. Cl. B27F 7/09; B25C 1/04; B25C 7/00

(52) U.S. Cl. 227/8; 227/120; 227/130; 227/111

(57) ABSTRACT

An automatic nailing assembly includes lower and upper skeletal frames for attachment to a pneumatic nailer; front and rear wheels mounted on the bottom frame; a linkage defined by pulleys or sprockets mounted on the frames interconnected by an endless belt or chain and driven by the rear wheel; a cam wheel for rotation by the pulley or sprocket on the upper frame; and a lever operated by the cam wheel to actuate a trigger for causing nails to be ejected at intervals from the nailer as the assembly rolls along a workpiece.

### CROSS REFERENCE TO RELATED APPLICATION

This application claims priority on U.S. Provisional Patent Application 61/202,781 filed Apr. 3, 2009.

### BACKGROUND OF THE INVENTION

1. Field of the Invention

This invention relates to an automatic nailing assembly.

2. Description of Related Art

There are many continuous nailing apparatuses of generally the type described herein. Examples of such apparatuses are found in U.S. Pat. Nos. 2,915,754, issued to Oscar A. Wandel on Dec. 8, 1959, 3,796,365, issued to Hugh N. Downing on Mar. 12, 1974, 3,984,040 issued to Arnold H. Fry on Oct. 5, 1976, 3,930,604 issued Roy S. Pitkin, Jr., et al on Jan. 6, 1976, 4,084,738, issued to Fredric H. Schneider on Apr. 18, 1978, 4,225,074, issued to Gerald D. Jacobson on Sep. 30, 1980, 4,523,706, issued to Norman S. Haley on Jun. 18, 1985, 5,110,027 issued to Allen C. Burlingame on May 5, 1992, 5,749,508 issued to Darrell C. Clothier on May 12, 1998, 6,269,996 issued to Richard Lynn McAllister on Aug. 7, 2001, 6,543,663, issued to David M. Davis on Apr. 8, 2003 and 6,712,256, issued to Kevin James Curry on Mar. 30, 2004.

In spite of a relatively large number of patents and applications relating to the subject matter in question, a need still exists for a simple automatic nailing apparatus which is easy and inexpensive to manufacture. The present invention is intended to meet such need.

### BRIEF SUMMARY OF THE INVENTION

Accordingly, the automatic nailing assembly of the present invention includes bottom and top skeletal frames for attachment to an off-the-shelf pneumatic nailer, front and rear wheels mounted on the bottom frame, pulley or sprockets mounted on the frames interconnected by a v-belt or chain and driven by the rear wheel, a cam wheel for rotation by the pulley or sprocket on the top frame, and a lever operated by the cam wheel to actuate a trigger to cause a nail to be ejected from the nailer. By rolling the nailer along a workpiece, nails are automatically intermittently ejected from the nailer, the spacing between the nails being dependent upon the speed of travel of the assembly along the workpiece.

### BRIEF DESCRIPTION OF THE DRAWINGS

The preferred embodiment of the invention is described below with reference to the accompanying drawings, wherein:

FIGS. 1 and 2 are isometric views of a nailing assembly in accordance with the invention from opposite sides and ends;

FIG. 3 is a side view of the assembly of FIGS. 1 and 2;

FIG. 4 is a side view of the assembly of FIGS. 1 to 3 with an element of the assembly shown in phantom outline;

FIG. 5 is a top view of the assembly of FIGS. 1 to 4;

FIG. 6 is a bottom view of the assembly of FIGS. 1 to 2;

FIG. 7 is an isometric view of the top portion of a trigger release used in the nailer assembly of FIGS. 1 to 6;

FIG. 8 is a top view of a cam wheel and lever system used in the assembly of FIGS. 1 to 6; and

FIGS. 9 and 10 are side views of the cam wheel and lever of FIG. 7 illustrating operation of the cam wheel and lever.

### DETAILED DESCRIPTION OF THE INVENTION

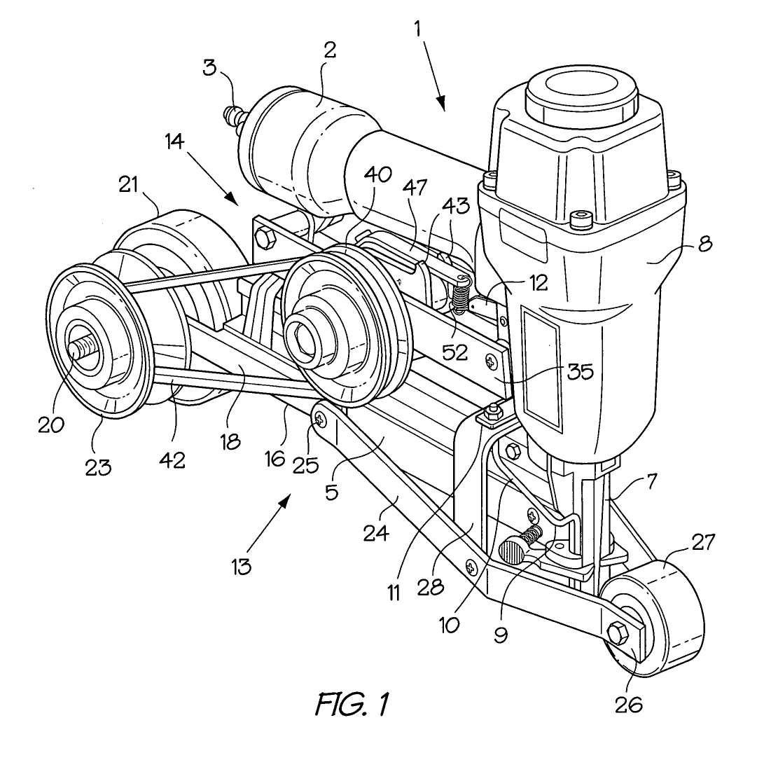

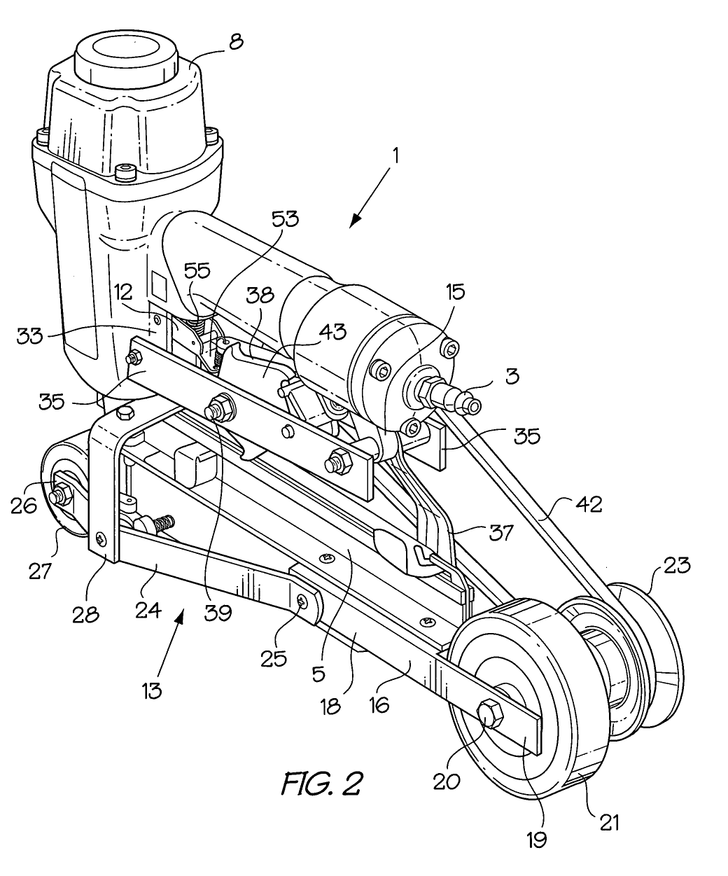

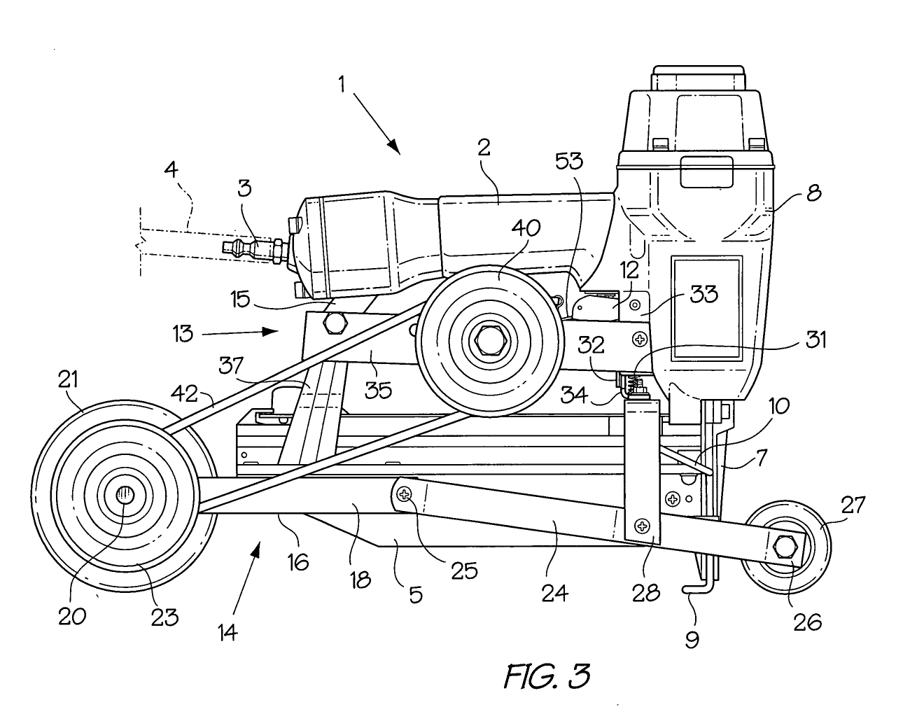

Referring to the drawings, the automatic nailing assembly of the present invention is intended for use with a conventional, off-the-shelf pneumatic nailer, which is indicated generally at 1 in FIGS. 1 to 3. In this case, the nailer 1 carried the name “Campbell Hausfeld”. The nailer 1 includes a housing 2 with a coupler 3 at one end thereof for receiving a hose 4 (FIG. 3). The hose 4 is connected to a compressor (not shown) for introducing air under pressure into the housing 2 to operate the nailer. Nails (not shown) are housed in a magazine 5 beneath the housing 2 for ejection through an opening 6 (FIG. 6) in a neck 7 extending downwardly from the head 8 of the housing 2.

During use, a trigger release 9 is pressed against a workpiece such as a sheet of plywood or particle board. The trigger release 9 (FIGS. 1 and 7) includes a wire 10 extending around the discharge end of the neck 7 and a generally L-shaped arm 11. When the release mechanism 9 is pushed upwardly it releases a normally manually operated trigger 12. Depressing the trigger 12 causes ejection of a nail. The nailer is then moved manually to another location and the process is repeated.

The nailing assembly of the present invention is mounted on and carries the nailer. The basic elements of the assembly are skeletal lower and upper frames indicated generally at 13 and 14, respectively. The lower frame 13 is mounted on the bottom of the nailer, and the upper frame 14 is connected at a front end to the housing 2 and at a rear end to an arm 15 extending downwardly from the rear end of the housing 2.

The lower frame 13 includes a rear section defined by a pair of sides 16 bolted to the bottom rear end of the magazine 6. The sides 16 have inverted L-shaped cross section front ends 18 and straight, vertical rear ends 19 extending rearwardly beyond the rear end of the magazine 5. The ends 19 receive a shaft 20 carrying a rear wheel 21, which can be studded for increased traction. A pulley 23 is mounted on an end of the shaft 20 extending outwardly beyond the wheel 21 and one rear side 16 of the frame 18.

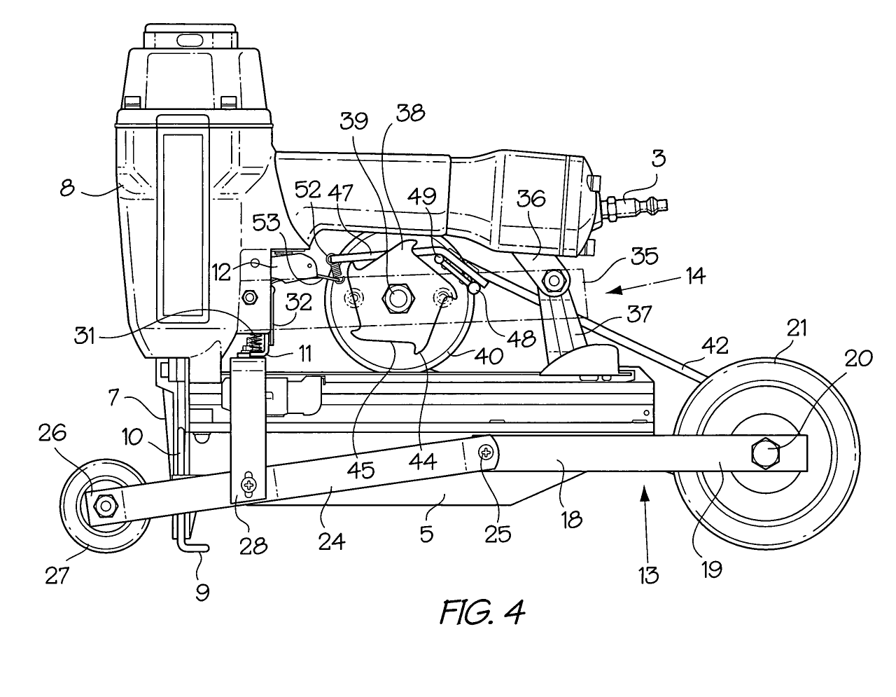

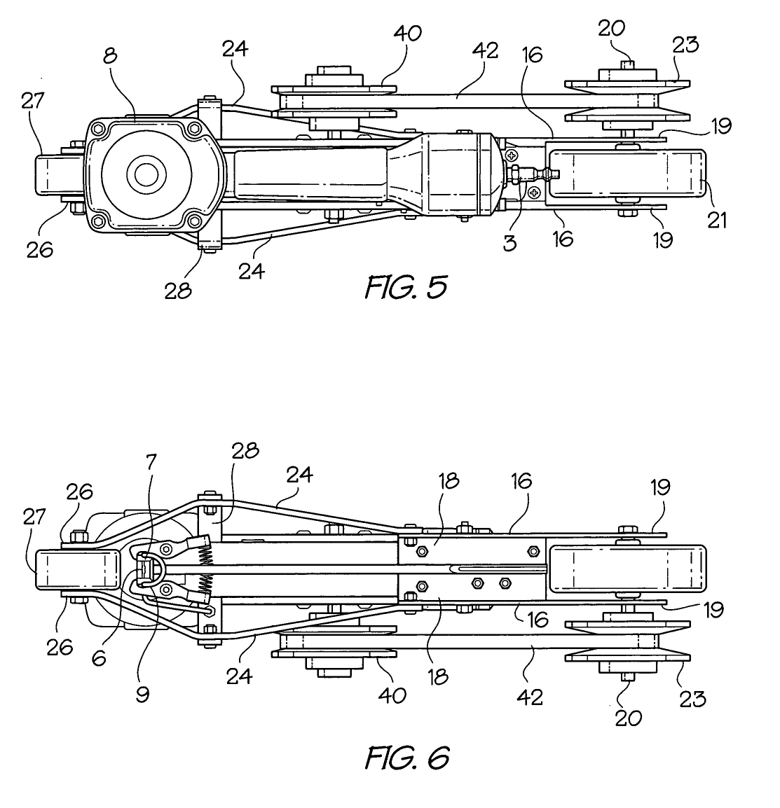

A front section of the lower frame 13 is defined by arms 24 pivotally connected to the leading ends of the sides 16 by bolts 25. The arms 24 diverge from the magazine 6 and then converge to a location beyond the front end of the nailer. The outer free ends 26 of the arms 24 support a front wheel or roller 27. An inverted U-shaped trigger release arm or crossbar 28 extends between the arms 24 at the junction between the diverging and converging ends thereof. The center of the crossbar 28 carries the L-shaped arm 11 of the trigger release 9. A helical spring 31 is mounted on the horizontal arm of the trigger release 9. The vertical arm of the release 9 extends into a square cross section tube 32 (FIGS. 3 and 4) fixedly mounted beneath the trigger 12 of the nailer. The tube 32 is mounted between the sides 33 of the trigger bracket. When the release 9 moves upwardly, a shoulder 34 (FIG. 3) on one side of the vertical arm of the release engages the bottom end of the tube 32 to limit upward movement of the release.

In use, when the assembly is pressed against the surface of a workpiece to receive nails, e.g. a sheet of plywood, the front wheel 27 is pushed upwardly causing the arms 24 to rotate around the axes of the bolts 25. The vertical inner end of the trigger release arm 11 moves upwardly into the tube 32. When the wheel 27 is removed from contact with the surface receiving nails, the spring 31 returns the trigger release 9 and the front end of the frame 13 to the rest positions.

The upper frame 14 includes a pair of sides 35, which are connected at their front ends to the trigger bracket sides and at their rear ends to the arm 15 extending downwardly from the nailer housing 2. The arm 15 also supports the top end of a bracket 37 connecting the rear end of the magazine 6 to the housing 2. A cam wheel 38 is rotatably mounted in the upper frame on a shaft defined by a bolt 39 extending through the sides 35 of the upper frame 15. An outer free end of the bolt 39 carries a pulley 40 which is vertically aligned with the pulley 23 on the outer end of the rear wheel shaft 20. An endless V-belt 42 extends around the pulleys 23 and 40. The pulleys 23 and 40 are adjustable so that the tension on the belt and the spacing of the nails can easily be adjusted. Rotation of the rear wheel 21 during movement of the nailer assembly along a surface causes corresponding rotation of the pulleys 23 and 40, and consequently rotation of the cam wheel 38. It will be appreciated that the pulleys 23 and 40, and the V-belt 42 can be replaced by sprockets and a chain (not shown).

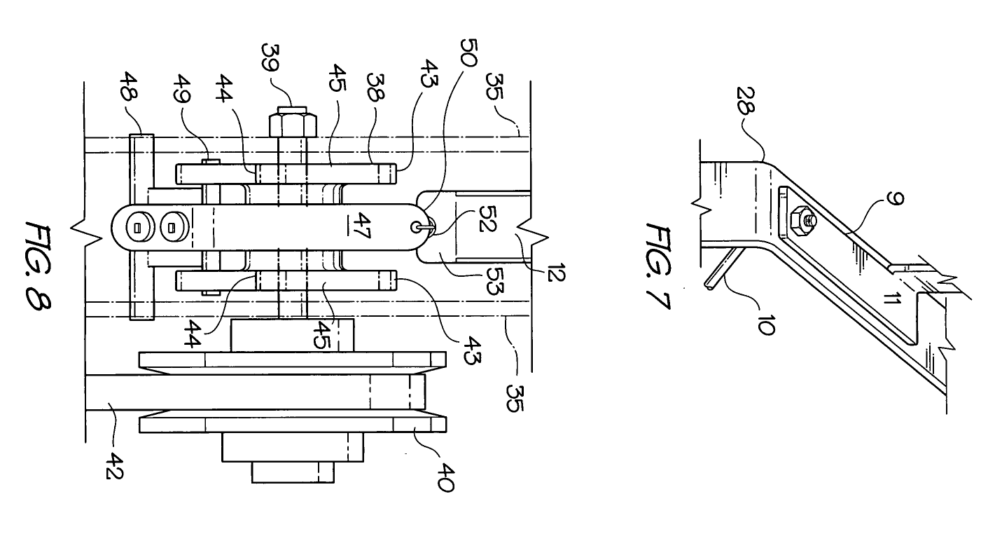

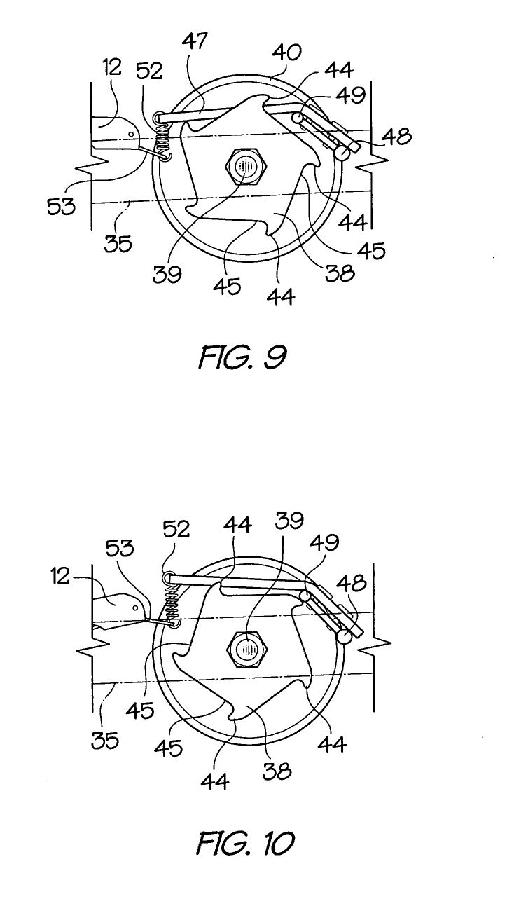

As best shown in FIGS. 4 and 8 to 10, the cam wheel 38 is shaped like a pulley with two sides 43. Each of the sides has a sawtooth periphery defined by alternating teeth or lobes 44 and grooves 45. A generally inverted V-shaped lever 47 is pivotally mounted in the upper frame 14 by means of a rod 48 extending outwardly from the trailing end of the lever 47 into the sides of the frame 14. A second rod 49 forwardly of the rod 48 extends outwardly from the sides of the lever 47 into overlapping relationship with the sides 43 of the cam wheel 38. As the wheel 38 rotates (counterclockwise in FIGS. 4, 9 and 10), the rod 49 slides up on the teeth 45 causing the lever 47 to pivot around the axis of the rod 48. Thus, the leading end 50 (FIG. 8) of the lever 47 is forced upwardly. Such leading end 50 of the lever is connected by a helical spring 52 to an arm 53 of the trigger 12 pivotally mounted between the sides of the trigger bracket.

An elongated handle (not shown) can be connected to the nailer 1 or to the upper frame 14 for pushing the assembly along a workpiece surface. In operation, for example when prefabricating a wall on a horizontal surface, the handle is used to push the assembly along a line marked on a panel being attached to framing. Alternatively, a laser pointer (not shown) can be attached to the nailer or to one of the frames 13 and 14 for providing a line on the workpiece. When the assembly is placed on the panel, the arms 24 of the lower frame 13 pivot around the bolts 25 so that the front wheel 27 moves upwardly and the trigger release 9 is depressed.

During movement of the assembly along the panel, rotation of the rear wheel 21 causes a corresponding rotation of the pulley 23. The V-belt 42 transmits such rotation to the pulley 40, which causes rotation of the cam wheel 38. As the cam wheel 38 rotates, the teeth 45 periodically engage the rod 49 causing the lever 47 to pivot to a trigger operating position to eject a nail from the nailer 1. The spacing of the nails is changed by adjusting the pulleys 23 and 40. If the rear pulley 20 is rotated clockwise (in the arrangement of FIGS. 1 and 3), the belt 42 is caused to run on a larger diameter area of the pulley. Turning of the front pulley 40 in a counterclockwise direction loosens the pulley, permitting the belt 42 to run on a smaller diameter. A larger diameter rear pulley 20 in combination with a smaller diameter front pulley 40 increases the frequency of trigger actuation and consequently closer spacing of the nails. Of course, the reverse is true when it is desired to increase the spacing of the nails. Thus, the adjustable pulleys allows for precise adjustment of nail spacing. The spacing of the nails can also be changed by replacing the cam wheel 38 with another cam wheel having more or less teeth. Obviously, the faster the movement of the assembly along a work surface the more frequent the occurrence of a nailing operation. In the absence of a handle, the nailer is pushed manually along the work surface.

1. An automatic nailing assembly for use with a pneumatic nailer, which includes a housing, a coupler at a rear end of the housing for receiving a compressor hose for introducing air under pressure into the housing to operate the nailer, a magazine for carrying nails beneath the housing, a neck extending downwardly from a front end of the housing carrying a plunger for ejecting nails one at a time from the magazine, a manually operable trigger and a trigger release at the bottom end of the neck which when pressed against a workpiece releases the trigger so that the trigger can be depressed to cause ejection of a nail from the magazine, the nailer assembly comprising:
a lower frame for mounting on a nailer, said lower frame having a rear section for extending rearwardly of the magazine and a front section pivotally connected to a front end of the rear section;
a rear wheel rotatably mounted on said rear section;
a front wheel rotatably mounted on the front section forwardly of said neck and trigger release;
a trigger release arm on said front section connected to said trigger release for releasing the trigger when the front wheel is pressed against a workpiece to cause the front section to pivot upwardly;
an upper frame for mounting on the housing above the lower frame;
a cam wheel having a plurality of lobes rotatable on said upper frame;
a linkage connecting said rear wheel to said cam wheel for rotating the cam wheel in unison with the rear wheel;
a lever extending between said cam wheel and the trigger for intermittent operation of said trigger during rotation of the cam wheel,
whereby, when the front wheel is pressed against the workpiece, the trigger is released, and by rolling the assembly along the workpiece, the trigger is pressed each time the lever rides over a lobe of the cam wheel.

2. The nailing assembly of claim 1, wherein said linkage includes a first shaft carrying said rear wheel mounted in said rear section of said lower frame, a first pulley on said shaft for rotation therewith, a second shaft carrying said cam mounted in said upper frame; a second pulley mounted on said second shaft; and an endless belt extending around said first and second pulleys.

3. The nailing assembly of claim 2, wherein the diameter of at least one of said first and second pulleys is adjustable for changing the tension on the endless belt or the spacing of the nails.

4. The nailing assembly of claim 1, wherein said linkage includes a first shaft carrying said rear wheel mounted in said rear section of said lower frame, a first sprocket on said shaft for rotation herewith, a second shaft carrying said cam mounted in said upper frame; a second sprocket mounted on said second shaft; and an endless chain extending around said first and second sprockets.
